(19) United States
(12) Patent Application Publication
(10) Pub. No.: US 2003/0177624 A1
(43) Pub. Date: Sep. 25, 2003

(54) Method for the manufacture of a spring core and device for implementing the method

(76) Inventor: Gerd Uwe Schmidt, Espelkamp (DE)

Correspondence Address: Samuels, Gauthier & Stevens LLP, Suite 3300, 225 Franklin Street, Boston, MA, 02110, US

(21) Appl. No.: 10/384,514

(22) Filed: Mar. 7, 2003

(30) Foreign Application Priority Data
Mar. 7, 2002 (DE) 10210033.0-14

(51) Int. Cl. B23Q 17/00

(52) U.S. Cl. 29/407.04; 29/703; 29/714; 29/720

(57) ABSTRACT

A method for the manufacture of a spring core, in which a plurality of springs are connected to one another, is designed such that after the connection of the springs, automatic defect control is performed.

### BACKGROUND OF THE INVENTION

1. Field of the Invention

The present invention relates to a method for the manufacture of a spring core in accordance with a method for the manufacture of a spring core in which a plurality of springs are connected to one another as well as a device for implementing the method.

2. Description of the Prior Art

For the manufacture of spring cores, in particular Bonnell spring cores, the individual springs which are made of wire, are first bent into spiral shapes and tied in a knot at the end, and which is why the particular free end is wound several times around the last bend of the spring. This takes place in a machine as does the subsequent connection of the springs to one another. The individual springs are put together in rows, wherein two rows lying side by side are connected by a so-called spiral wire, which connects the final loops of any two adjacent springs of two adjoining rows, so that there is also an interconnection over the entire length of the rows.

In the production of the springs as well as the subsequent connection, there may be production defects due to the malfunctioning or misadjustment of the machines. For instance, the knots of the individual springs may be too short, such that there is no secure hold, or too long, such that the overhanging end may result in damage to the mattress material. There is also the risk that knotting will not occur at all. In this case, the flawless functioning of the corresponding spring cannot be guaranteed and a connection with the adjoining spring is practically ruled out.

There may likewise be defects in connecting the individual rows via the spiral wire. In order to fasten the end of the spiral wire, its end eyelets must be closed by bending. If not, the spiral wire may protrude outwards and damage the mattress covering. There is also the risk that the connection of the final springs may take place with too few loops of the spiral wire, as a result of which this connection will not be sufficiently secure.

Another defect that may occur in the automatic connection of the individual rows of springs lies in a so-called ladder, in which the spiral wire does not at all connect the springs and it may lie above as well as below the end loops of the springs.

The occurring defects cited have so far, if at all, only been detected by the personnel operating the machines. But since one operator is simultaneously responsible for the device or monitoring of several machines, a sufficient and effective control is not possible, and thus defects cannot be promptly remedied. This greatly increases the reject ratio when these defects are determined in a subsequent visual inspection of the finished spring cores.

However, such a visual, final inspection is frequently insufficient, because specific, less conspicuous defects are not detected. Thus corresponding spring cores are sent for further processing, as a result of which, the usable life of the mattresses manufactured with it may be reduced.

The cited waste of the spring cores necessitated by the defect results in a considerable expense in production, while a heretofore impossible optimization of the quality control stands in the way of the flawless usage desired.

### SUMMARY OF THE INVENTION

The present invention, therefore, is based on the object of further developing a method of manufacturing spring cores, such that the waste due to production is minimized and quality assurance is optimized.

This object is achieved by a method that includes performing an automatic defect control after the springs are connected.

With the help of the method according to the present invention, early detection of the described defects due to production is now possible, as a result of which interventions for corrections may be made in the production flow.

A defect recognition may be signaled visually or acoustically, the type of defect being directly displayable on a display, for example, so that the supervisor may indirectly ensure eliminating a defect.

In addition, the method according to the present invention also offers the possibility of obtaining additional information, such as the width of the spring core, its height, and/or its length.

Here, the width of the spring core is defined via the number of springs, their distance to one another, as well as the diameter of the particular top and bottom ring.

The height of the spring core may be determined via the threads per unit and slope of the individual springs.

The length of the spring core, in turn, may likewise be determined from the number of springs as well as the diameter of the particular top and bottom ring of the springs.

Aside from the quality assurance mentioned, the present invention offers the further advantage that not only is the presence of a defect detected, but also the type, so that a specific repair is possible without any problems. This minimizes the waste to a considerable extent.

Because of the accurate defect control, there is also the possibility of certifying each individual spring core, thereby ensuring the processing and a special quality to the end consumer.

The defect control may take place via an optical control device.

This is expediently made up of at least one still camera, preferably an area camera, through which the spring core is photographed in sections, after which the digitized shot of each section is compared with a digitized template.

A separate still camera may be allocated to the upper and lower side of the spring core to be controlled. The still camera being installed after a device in which the individual springs are fitted together into a spring core.

Instead of the defect control via at least one still camera, other suitable optical control devices are also conceivable, for example, those that determine the necessary measuring data with the help of a laser beam.

At any rate, the control device is connected to a computer, to which the display mentioned, is in turn connected. Stored in the computer are the nominal data, which serve as the basis for comparison of the images detected, e.g., photographs taken.

Other advantageous embodiments of the present invention are characterized in the sub-claims.

### DESCRIPTION OF THE DRAWINGS

An embodiment of a device for implementing the method is described in the following with the help of the drawing attached.

FIG. 1 shows a schematic side view of a device.

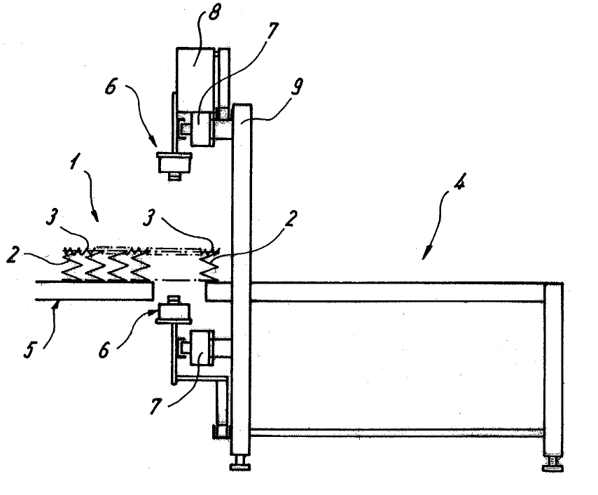

### DESCRIPTION OF THE PREFERRED EMBODIMENT

In the figure, a device is shown, with which the defect control of spring core 1 is implementable, made up of a plurality of springs 7 connected via spiral wire 3.

Table underframe 4, on which spring core 1 is guided with positional accuracy after leaving table 5, is connected at a distance to table 5, which is a component of a device not shown, in which the individual springs 2 are fitted into spring core 1.

On guide rod 9, still camera 6 is arranged such that it is height adjustable and is facing the upper side of spring core 1. Another still camera 6 is provided beneath the lower side of spring core 1, which with respect to its height, however, is firmly connected to guide rod 9. Both still cameras 6 are positioned in the slot region between table underframe 4 and table underframe 5.

Furthermore, they are each stored on transversal bar 7, which exhibits a linear driving gear, with which the still cameras 6 may travel perpendicular to the direction of flow of spring core 1, marked by an arrow. Here, the still cameras 6 are coupled to one another such that synchronization is ensured.

An actuating drive 8, which corresponds to guide rod 9, is provided for height adjustment of upper still camera 6.

During the run of spring core 1, as mentioned, photos are taken in sections by the still cameras and compared with a template stored in a connected computer, not illustrated. In the event of a deviation therefrom, for example within a certain tolerance limit, this is displayed as a defect and optically signaled, for instance.

What is claimed is:

1. A method for the manufacture of a spring core, in which a plurality of springs are connected to one another, characterized in that after the connection of the springs, automatic defect control is performed.

2. The method according to claim 1, characterized in that the defect control takes place via an optical control device.

3. The method according to claim 2, characterized in that the defect control takes place via at least one still camera, in which the spring core is photographed in sections on the upper and/or lower side, and afterwards, the shot of each section is compared with a template.

4. A device for implementing the method according to claim 1, characterized in that at least one optical control device is provided, which is connected to a computer.

5. The device according to claim 4, characterized in that a display is connected to the computer.

6. The device according to claim 4, characterized in that the control device is made up of two still cameras, one of which is allocated to the upper side of the spring core and the other to its lower side.

7. The device according to claim 6, characterized in that the still camera is designed as an area camera.

8. The device according to claim 6, characterized in that the still cameras may travel perpendicular to the direction of flow of the spring core.

9. The device according to claim 8, characterized in that the still cameras are each fastened to a transversal bar, each of which is connected with a guide rod fastened to a table underframe.

10. The device according to claim 9, characterized in that the still camera allocated to the upper side of the spring core is fastened height-adjustably to the guide rod.

11. The device according to claim 10, characterized in that an actuating drive is provided for height adjustment.

12. The device according to one of claim 4 to 11, characterized in that the still cameras may travel via at least one linear driving gear arranged on one of the transversal bars.

13. The device according to one of claim 4 to 11, characterized in that the table underframe for accommodating the spring core is positioned at a distance to a table of a device for the manufacture of the spring core.

14. The device according to one of claim 6 to 11, characterized in that the still cameras are arranged in the region of the slot formed by the distance between the table underframe and the table.
